(19) United States
(12) Patent Application Publication
(10) Pub. No.: US 2021/0263244 A1
(43) Pub. Date: Aug. 26, 2021

(54) UNIDIRECTIONAL TRANSMISSION DEVICE AND METHOD FOR TRANSMITTING SIGNAL IN UNIDIRECTIONAL MANNER

(71) Applicant: AuthenX Inc., Hsinchu County (TW)

(72) Inventors: Chun-Chiang YEN, Hsinchu County (TW); Po-Kuan SHEN, Hsinchu County (TW); Sheng-Fu LIN, Hsinchu County (TW); Chiu-Lin YU, Hsinchu County (TW); Kai-Lun HAN, Hsinchu County (TW); Jenq-Yang CHANG, Hsinchu County (TW); Mao-Jen WU, Hsinchu County (TW)

(21) Appl. No.: 17/170,905

(22) Filed: Feb. 9, 2021

Related U.S. Application Data
(60) Provisional application No. 62/979,441, filed on Feb. 21, 2020.

(51) Int. Cl. G02B 6/42; H04B 10/64; H04B 10/114; H01L 33/62; H01L 31/0203

(52) U.S. Cl. CPC G02B 6/4214; H04B 10/64; H01L 31/0203; H01L 33/62; H04B 10/1141

(57) ABSTRACT

A unidirectional transmission device includes at least one substrate, at least one light source, and at least one light-sensing element. The at least one substrate includes at least one recess. The at least one light source is configured to transform an electrical signal into an optical signal, and transmit the optical signal. The at least one light-sensing element is configured to receive the optical signal, and transform the optical signal into the electrical signal, wherein the at least one recess is configured to dispose the at least one light source, or configured to dispose the at least one light-sensing element, or configured to reflect the optical signal.

### CROSS-REFERENCE TO RELATED APPLICATION

This application claims priority to U.S. Provisional Patent Application Ser. No. 62/979,441, filed Feb. 21, 2020, which is herein incorporated by reference.

### BACKGROUND

### Field of Invention

The present disclosure relates to an isolating device and a method for transmitting signals. More particularly, the present disclosure relates to a unidirectional transmission device and a method for transmitting signals in a unidirectional manner.

### Description of Related Art

With the development of the internet, life is getting more convenient. For obtaining information conveniently and instantaneously, the development of the internet of things (IoT) trends higher day by day. However, the information safety issues occur accordingly.

Popularization of mobile devices with internet, financial technology (FinTech), mobile payment, and online banking need a lot of personal information (e.g., biological characteristics) for the security of the transaction certification. The huge daily transaction exposes personal information to high risks.

If a circuit is used for transaction certification, there still exists risks due to the circuit can be used to transmit data in a bidirectional manner. Even though software such as a fire wall is used to enhance the security of the transaction certification, the above-mention risks still exist, and the transmission speed will be affected extremely so as to decrease the system efficiency.

### SUMMARY

The foregoing presents a simplified summary of the disclosure in order to provide a basic understanding to the reader. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

The present disclosure provides a unidirectional transmission device. The unidirectional transmission device includes at least one substrate, at least one light source, and at least one light-sensing element. The at least one substrate includes at least one recess. The at least one light source is configured to transform an electrical signal into an optical signal, and transmit the optical signal. The at least one light-sensing element is configured to receive the optical signal, and transform the optical signal into the electrical signal, wherein the at least one recess is configured to dispose the at least one light source, or configured to dispose the at least one light-sensing element, or configured to reflect the optical signal.

The present disclosure provides a unidirectional transmission device. The unidirectional transmission device includes at least one substrate, a reflecting layer, at least one light source, and at least one light-sensing element. The reflecting layer is disposed above the at least one substrate. The at least one light source is disposed on the substrate, configured to transform an electrical signal into an optical signal, and transmit the optical signal to the reflecting layer. The at least one light-sensing element is disposed on the substrate, configured to receive the optical signal from the reflecting layer, and transform the optical signal into the electrical signal.

A method for transmitting signals in a unidirectional manner is provided. The method for transmitting signals in a unidirectional manner includes steps of: transforming an electrical signal into an optical signal, and transmitting the optical signal through at least one light source; and receiving the optical signal, and transforming the optical signal into the electrical signal through at least one light-sensing element, wherein at least one recess of at least one substrate is configured to dispose the at least one light source, or configured to dispose the at least one light-sensing element, or configured to reflect the optical signal.

Therefore, based on the technical content of the present disclosure, if electrical devices adopt the unidirectional transmission device and the method for transmitting signals in a unidirectional manner of the present disclosure to perform transaction certification, the security of the transaction certification is increased due to the unidirectional transmission characteristic of the unidirectional transmission device. Since data related to transaction can be transmitted in a unidirectional manner, the data related to transaction cannot be obtained reversely so as to ensure the security of the transaction certification.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 depicts a schematic diagram of a unidirectional transmission device according to one embodiment of the present disclosure;

FIG. 2 depicts a schematic diagram of a unidirectional transmission device according to one embodiment of the present disclosure;

FIG. 3 depicts a schematic diagram of a unidirectional transmission device according to one embodiment of the present disclosure;

FIG. 4 depicts a schematic diagram of a unidirectional transmission device according to one embodiment of the present disclosure;

FIG. 5 depicts a schematic diagram of a unidirectional transmission device according to one embodiment of the present disclosure;

FIG. 6 depicts a schematic diagram of a unidirectional transmission device according to one embodiment of the present disclosure;

FIG. 7 depicts a schematic diagram of a unidirectional transmission device according to one embodiment of the present disclosure;

FIG. 8 depicts a schematic diagram of a unidirectional transmission device according to one embodiment of the present disclosure;

FIG. 9 depicts a schematic diagram of a unidirectional transmission device according to one embodiment of the present disclosure;

FIG. 10 depicts a schematic diagram of a unidirectional transmission device according to one embodiment of the present disclosure;

FIG. 11 depicts a schematic diagram of a unidirectional transmission device according to one embodiment of the present disclosure;

FIG. 12 depicts a schematic diagram of a unidirectional transmission device according to one embodiment of the present disclosure;

FIG. 13 depicts a schematic diagram of a unidirectional transmission device according to one embodiment of the present disclosure; and

FIG. 14 depicts a flowchart of a method for transmitting signals in a unidirectional manner according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts. However, the embodiments provided herein are intended as illustrative only since numerous modifications and variations therein will be apparent to those skilled in the art. Description of the operation does not intend to limit the operation sequence. Any structures resulting from recombination of elements with equivalent effects are within the scope of the present invention.

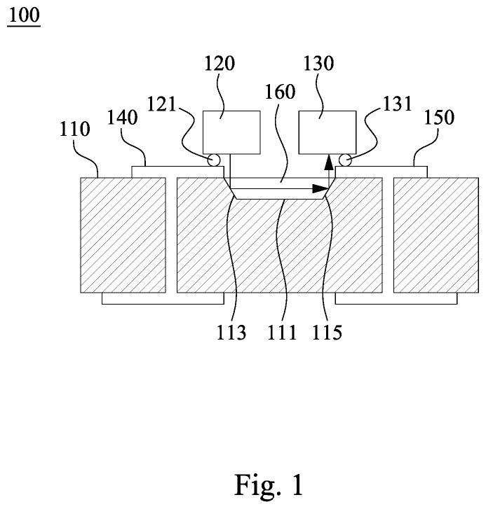

FIG. 1 depicts a schematic diagram of a unidirectional transmission device 100 according to one embodiment of the present disclosure. As shown in the figure, the unidirectional transmission device 100 includes at least one substrate 110, at least one light source 120, and at least one light-sensing element 130. The at least one substrate 110 includes at least one recess 111. In one embodiment, the at least one recess 111 includes a first reflecting surface 113 and a second reflecting surface 115. In one embodiment, the light source 120 can be implemented by any element which can generate light.

In one embodiment, the unidirectional transmission device 100 further includes a first conductor 140 and a second conductor 150. As shown in the figure, the at least one light source 120 is connected to the first conductor 140 in a flip bonding manner, and the at least one light-sensing element 130 is connected to the second conductor 150 in a flip bonding manner. In another embodiment, the first conductor 140 is isolated from the second conductor 150. For example, the first conductor 140 is not physically connected to the second conductor 150. In addition, the first conductor 140 is not directly or indirectly connected to the second conductor 150 in an electrical manner. In one embodiment, the at least one light source 120 and the at least one light-sensing element 130 are connected to connection points (e.g., round points 121, 131 as shown in the figure) of the first conductor 140 and the second conductor 150 in a flip bonding manner, and the material of the connection points can be gold, tin, alloy or graphite.

The operations of the unidirectional transmission device 100 are described as follows. The at least one light source 120 receives an electrical signal from the first conductor 140, and transforms the electrical signal into an optical signal (e.g., a signal with optical phase and light intensity). The at least one light source 120 then transmits the optical signal to the first reflecting surface 113, and the first reflecting surface 113 reflects the optical signal from the at least one light source 120. Subsequently, the second reflecting surface 115 reflects the optical signal from the first reflecting surface 113, and transmits the optical signal to the at least one light-sensing element 130. In addition, the at least one light-sensing element 130 receives the optical signal, transforms the optical signal into the electrical signal, and transmits the electrical signal through the second conductor 150.

In view of the above, if electrical devices adopt the unidirectional transmission device 100 of the present disclosure to perform transaction certification, the security of the transaction certification is increased due to the unidirectional transmission characteristic of the unidirectional transmission device 100. Since data related to transaction can be transmitted in a unidirectional manner, the data related to transaction cannot be obtained reversely so as to ensure the security of the transaction certification.

In one embodiment, the unidirectional transmission device 100 can be optical isolator. In one embodiment, the first conductor 140 and the second conductor 150 penetrate the at least one substrate 110 in order to connected to the at least one light source 120 and the at least one light-sensing element 130 respectively. In another embodiment, the at least one recess 111 further includes a medium 160, and the medium 160 is configured to transmit the optical signal. The medium 160 includes one of air, silicon, silica, polymer, and an element which is penetrable by light with wavelength ranges from 750 nm to 1650 nm. In one embodiment, the optical signal can be transmitted in vacuum without any medium.

In one embodiment, the wavelength of the optical signal ranges from 850 nm (nanometer) to 1550 nm. In another embodiment, the wavelength of the optical signal ranges from 750 nm to 1650 nm. In one embodiment, the material of the at least one substrate 110 can be silicon, glass, ceramics, aluminum oxide, silicon nitride or polymer. However, the present disclosure is not limited to the above-mentioned embodiments as shown in FIG. 1, and it is merely an example for illustrating one of the implements of the present disclosure.

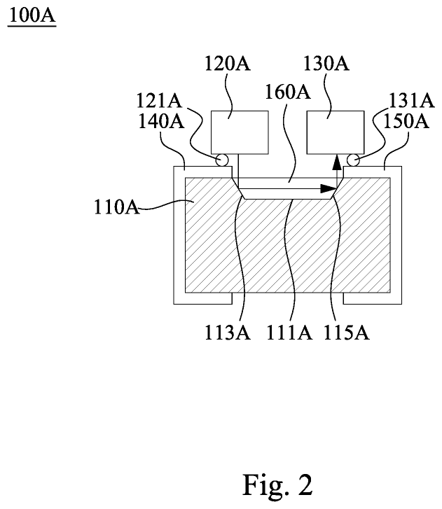

FIG. 2 depicts a schematic diagram of a unidirectional transmission device 100A according to one embodiment of the present disclosure. Compared with the unidirectional transmission device 100 shown in FIG. 1, the disposition of the first conductor 140A and the second conductor 150A of the unidirectional transmission device 100A shown in FIG. 2 is different.

As shown in FIG. 2, the first conductor 140A and the second conductor 150A respectively cover the outside of the at least one substrate 110A in order to connected to the at least one light source 120A and the at least one light-sensing element 130A. In one embodiment, the first conductor 140A and the second conductor 150A can be formed on the outside of the at least one substrate 110A by coating. It is noted that, the element in FIG. 2, whose symbol is similar to the symbol of the element in FIG. 1, has similar structure feature in connection with the element in FIG. 1. Therefore, a detail description regarding the structure feature of the element in FIG. 2 is omitted herein for the sake of brevity. Furthermore, the present disclosure is not limited to the structure as shown in FIG. 2, and it is merely an example for illustrating one of the implements of the present disclosure.

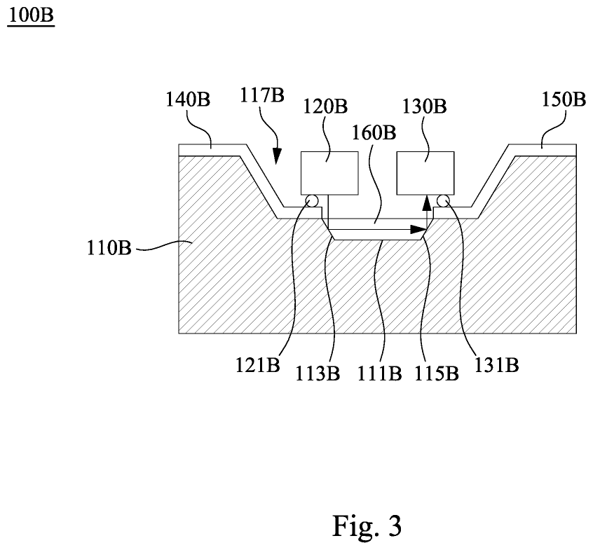

FIG. 3 depicts a schematic diagram of a unidirectional transmission device 100B according to one embodiment of the present disclosure. Compared with the unidirectional transmission device 100 shown in FIG. 1, the disposition of the first conductor 140B and the second conductor 150B of the unidirectional transmission device 100B shown in FIG. 3 is different.

As shown in FIG. 3, the first conductor 140B and the second conductor 1508 are located on a surface of the at least one substrate 1108, and respectively connected to the at least one light source 120B and the at least one light-sensing element 130B. In one embodiment, at least one substrate 1108 further includes another recess 117B, and the at least one light source 120B and the at least one light-sensing element 130B can be disposed in the recess 117B. It is noted that, the element in FIG. 3, whose symbol is similar to the symbol of the element in FIG. 1, has similar structure feature in connection with the element in FIG. 1. Therefore, a detail description regarding the structure feature of the element in FIG. 3 is omitted herein for the sake of brevity. Furthermore, the present disclosure is not limited to the structure as shown in FIG. 3, and it is merely an example for illustrating one of the implements of the present disclosure.

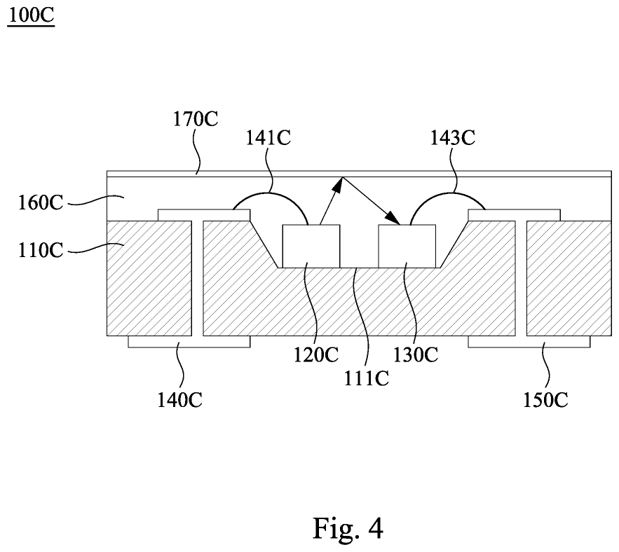

FIG. 4 depicts a schematic diagram of a unidirectional transmission device 100C according to one embodiment of the present disclosure. Compared with the unidirectional transmission device 100 shown in FIG. 1, the unidirectional transmission device 100C shown in FIG. 4 further includes a reflecting layer 170C, and some of the dispositions are different.

As shown in FIG. 4, the reflecting layer 170C is disposed above the at least one substrate 110C. In addition, the at least one light source 120C is disposed in the recess 111C, and connected to the first conductor 140C. The at least one light-sensing element 130C is disposed in the recess 111C, and connected to the second conductor 150C. For example, the at least one light source 120C is connected to the first conductor 140C through a connection line 141C, and the at least one light-sensing element 130C is connected to the second conductor 150C through a connection line 143C.

Compared with disposing the light source and the light-sensing element on a flat substrate, the at least one light source 120C and the at least one light-sensing element 130C of the present disclosure are disposed in the recess 111C, such that the top of the at least one light source 120C and the top of the at least one light-sensing element 130C are closer to the first conductor 140C and the second conductor 150C. Therefore, the connection line 141C between the first conductor 140C and the at least one light source 120C can be effectively shortened, so as to decrease the loss. Similarly, the connection line 143C between the second conductor 150C and the at least one light-sensing element 130C can also be effectively shortened, so as to decrease the loss.

The operations of the unidirectional transmission device 100C are described as follows. The at least one light source 120C receives the electrical signal from the first conductor 140C, transforms the electrical signal into the optical signal, and transmits the optical signal to the reflecting layer 170C. The reflecting layer 170C reflects the optical signal to the at least one light-sensing element 130C. Subsequently, the at least one light-sensing element 130C receives the optical signal, transforms the optical signal into the electrical signal, and transmits the electrical signal through the second conductor 150C. It is noted that, the element in FIG. 4, whose symbol is similar to the symbol of the element in FIG. 1, has similar structure feature in connection with the element in FIG. 1. Therefore, a detail description regarding the structure feature of the element in FIG. 4 is omitted herein for the sake of brevity. Furthermore, the present disclosure is not limited to the structure as shown in FIG. 4, and it is merely an example for illustrating one of the implements of the present disclosure.

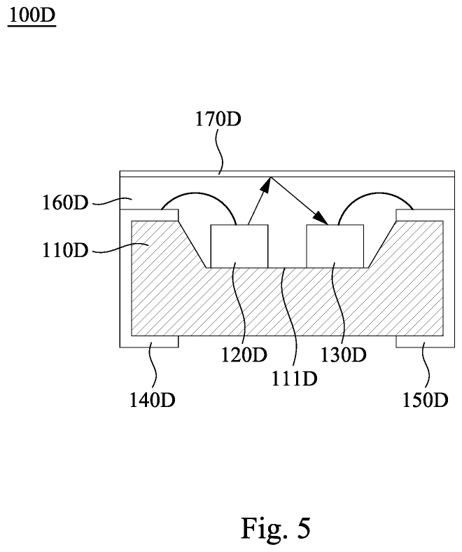

FIG. 5 depicts a schematic diagram of a unidirectional transmission device 100D according to one embodiment of the present disclosure. Compared with the unidirectional transmission device 100C shown in FIG. 4, the disposition of the first conductor 140D and the second conductor 150D of the unidirectional transmission device 100D shown in FIG. 5 is different.

As shown in FIG. 5, the first conductor 140D and the second conductor 150D respectively cover the outside of the at least one substrate 110D in order to connected to the at least one light source 120D and the at least one light-sensing element 130D. It is noted that, the element in FIG. 5, whose symbol is similar to the symbol of the element in FIG. 4, has similar structure feature in connection with the element in FIG. 4. Therefore, a detail description regarding the structure feature of the element in FIG. 5 is omitted herein for the sake of brevity. Furthermore, the present disclosure is not limited to the structure as shown in FIG. 5, and it is merely an example for illustrating one of the implements of the present disclosure.

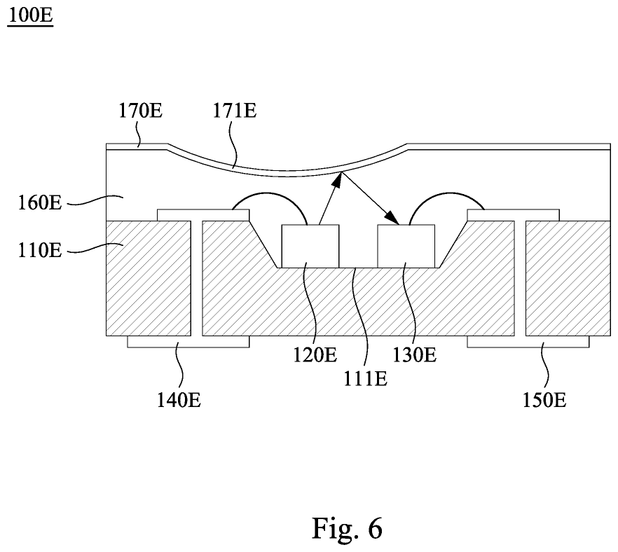

FIG. 6 depicts a schematic diagram of a unidirectional transmission device 100E according to one embodiment of the present disclosure. Compared with the unidirectional transmission device 100C shown in FIG. 4, the reflecting layer 170E of the unidirectional transmission device 100E in FIG. 6 further includes a curved surface 171E.

As shown in FIG. 6, the at least one light source 120E transmits the optical signal to the curved surface 171E of the reflecting layer 170E, and the curved surface 171E of the reflecting layer 170E reflects the optical signal to the at least one light-sensing element 130E. In view of the above, since the reflecting layer 170E further includes the curved surface 171E, the reflectivity of the optical signal can be enhanced by setting the curvature of the curved surface 171E. It is noted that, the element in FIG. 6, whose symbol is similar to the symbol of the element in FIG. 4, has similar structure feature in connection with the element in FIG. 4. Therefore, a detail description regarding the structure feature of the element in FIG. 6 is omitted herein for the sake of brevity. Furthermore, the present disclosure is not limited to the structure as shown in FIG. 6, and it is merely an example for illustrating one of the implements of the present disclosure. It will be apparent to those skilled in the art that various modifications and variations can be made to the shaped of the reflecting layer 170E of the present disclosure without departing from the scope or spirit of the present disclosure in order to enhance the reflectivity of the optical signal.

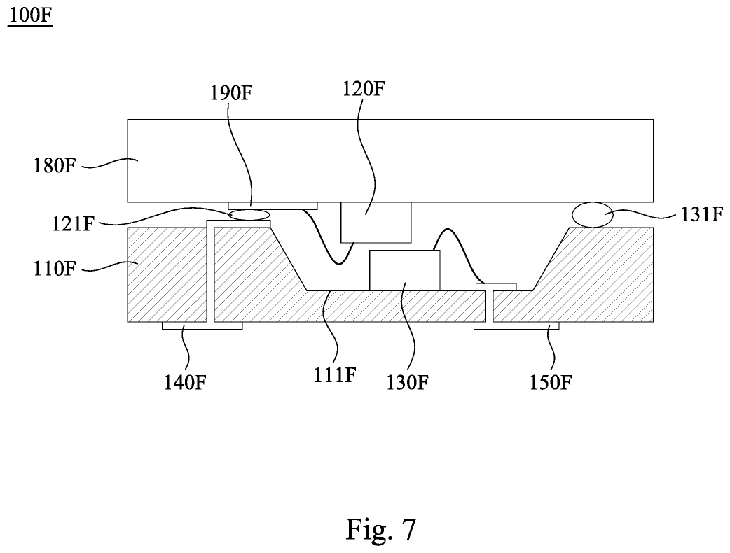

FIG. 7 depicts a schematic diagram of a unidirectional transmission device 100F according to one embodiment of the present disclosure. Compared with the unidirectional transmission device 100 shown in FIG. 1, the unidirectional transmission device 100F in FIG. 7 includes a first substrate 110F and a second substrate 180F, and some of the dispositions are different.

As shown in FIG. 7, the first substrate 110F includes at least one recess 111F. The at least one light-sensing element 130F is disposed in the at least one recess 111F, and the at least one light source 120F is disposed on the second substrate 180F. In one embodiment, the first substrate 110F and the second substrate 180F can be implemented by the same material or different materials.

In addition, the first conductor 140F penetrates the first substrate 110F and connects to the at least one light source 120F through a third conductor 190F, and the second conductor 150F penetrates the first substrate 110F and connects to the at least one light-sensing element 130F. Besides, the first conductor 140F and the third conductor 190F can be connected together through a conducting material 121F. In addition, a conducting material 131F is disposed between the first substrate 110F and the second substrate 180F. In one embodiment, the conducting materials 121F, 131F can be gold, tin, alloy, graphite, and so on.

The operations of the unidirectional transmission device 100F are described as follows. The at least one light source 120F receives the electrical signal from the first conductor 140F through the third conductor 190F, transforms the electrical signal into the optical signal, and transmits the optical signal to the at least one light-sensing element 130F directly. The at least one light-sensing element 130F receives the optical signal, transforms the optical signal into the electrical signal, and transmits the electrical signal through the second conductor 150F.

Compared with transmitting the optical signal through reflecting, the at least one light source 120F in FIG. 7 transmits the optical signal to the at least one light-sensing element 130F directly, such that the transmitting path of the optical signal can be effectively shorten so as to decrease the loss. It is noted that, the element in FIG. 7, whose symbol is similar to the symbol of the element in FIG. 1, has similar structure feature in connection with the element in FIG. 1. Therefore, a detail description regarding the structure feature of the element in FIG. 7 is omitted herein for the sake of brevity. Furthermore, the present disclosure is not limited to the structure as shown in FIG. 7, and it is merely an example for illustrating one of the implements of the present disclosure.

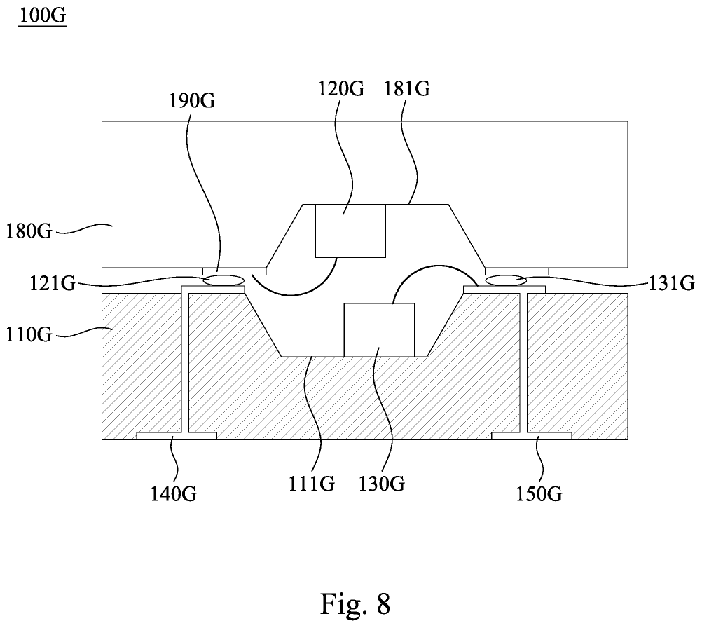

FIG. 8 depicts a schematic diagram of a unidirectional transmission device 100G according to one embodiment of the present disclosure. Compared with the unidirectional transmission device 100F shown in FIG. 7, the second substrate 180G of the unidirectional transmission device 100G in FIG. 8 further includes a recess 181G.

As shown in FIG. 8, the at least one light source 120G is disposed in the recess 181G, and the at least one light-sensing element 130G is disposed in the recess 111G. In one embodiment, the recess 111G and the recess 181G is disposed face to face. It is noted that, the element in FIG. 8, whose symbol is similar to the symbol of the element in FIG. 7, has similar structure feature in connection with the element in FIG. 7. Therefore, a detail description regarding the structure feature of the element in FIG. 8 is omitted herein for the sake of brevity. Furthermore, the present disclosure is not limited to the structure as shown in FIG. 8, and it is merely an example for illustrating one of the implements of the present disclosure.

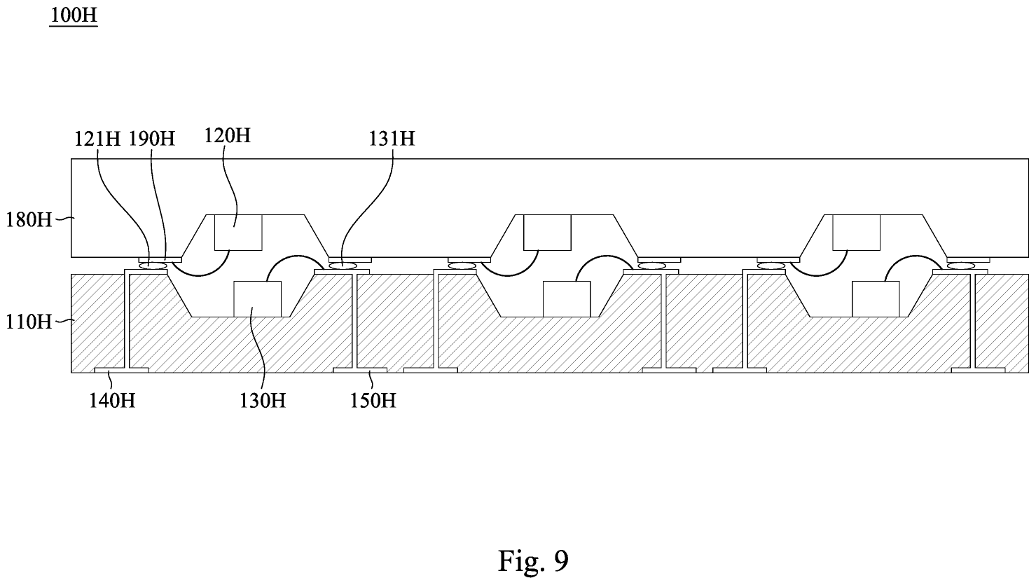

FIG. 9 depicts a schematic diagram of a unidirectional transmission device 100H according to one embodiment of the present disclosure. As shown in the figure, FIG. 9 depicts an embodiment that the unidirectional transmission devices are disposed in parallel to form an integrated device 100H. It is noted that, the element in FIG. 9, whose symbol is similar to the symbol of the element in FIG. 8, has similar structure feature in connection with the element in FIG. 8. Therefore, a detail description regarding the structure feature of the element in FIG. 9 is omitted herein for the sake of brevity. Furthermore, the present disclosure is not limited to the structure as shown in FIG. 9, and it is merely an example for illustrating one of the implements of the present disclosure.

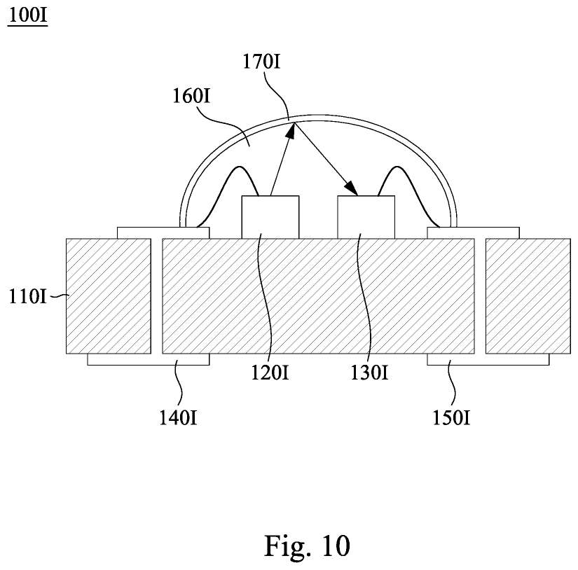

FIG. 10 depicts a schematic diagram of a unidirectional transmission device 100I according to one embodiment of the present disclosure. As shown in the figure, the unidirectional transmission device 100I includes at least one substrate 110I, at least one light source 120I, at least one light-sensing element 130I, and a reflecting layer 170I. The at least one light source 120I is disposed on the at least one substrate 110I. The at least one light-sensing element 130I is disposed on the at least one substrate 110I. The reflecting layer 170I is disposed above the at least one substrate 110I.

In one embodiment, the unidirectional transmission device 100I includes a first conductor 140I and a second conductor 150I. As shown in the figure, the first conductor 140I is connected to the at least one light source 120I, and the second conductor 150I is connected to the at least one light-sensing element 130I. In another embodiment, the first conductor 140I is isolated from the second conductor 150I. For example, the first conductor 140I is not physically connected to the second conductor 150I. In addition, the first conductor 140I is not directly or indirectly connected to the second conductor 150I in an electrical manner.

The operations of the unidirectional transmission device 100I are described as follows. The at least one light source 120I receives the electrical signal from the first conductor 140I, transforms the electrical signal into the optical signal, and transmits the optical signal to the reflecting layer 170I. The reflecting layer 170I reflects the optical signal to the at least one light-sensing element 130I. Subsequently, the at least one light-sensing element 130I receives the optical signal, transforms the optical signal into the electrical signal, and transmits the electrical signal through the second conductor 150I. However, the present disclosure is not limited to the above-mentioned embodiments as shown in FIG. 10, and it is merely an example for illustrating one of the implements of the present disclosure.

In one embodiment, the first conductor 140I and the second conductor 150I penetrate the at least one substrate 110I in order to connect to the at least one light source 120I and the at least one light-sensing element 130I respectively. In another embodiment, the reflecting layer 170I can be a curved surface. The at least one light source 120I transmits the optical signal to the curved surface of the reflecting layer 170I, and the curved surface of the reflecting layer 170I reflects the optical signal to the at least one light-sensing element 130I.

In one embodiment, at least one light source 120I can be a vertical-cavity surface-emitting laser (VCSEL). Compared with edge emitting lasers, the at least one light source 120I of the present disclosure can be implemented by VCSEL with low power consumption. Therefore, the at least one light source 120I of the present disclosure is a power saving device in contrast to the edge emitting laser. However, the present disclosure is not limited to the above-mentioned embodiments as shown in FIG. 10, and it is merely an example for illustrating one of the implements of the present disclosure. It will be apparent to those skilled in the art that various modifications and variations can be made to the type of the laser of the present disclosure for implementing the at least one light source 120I, without departing from the scope or spirit of the present disclosure.

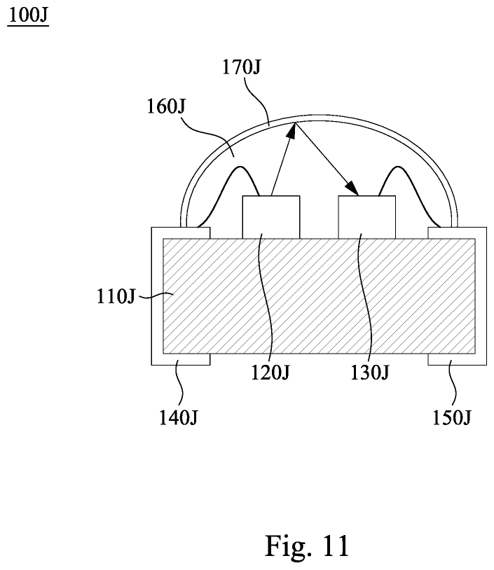

FIG. 11 depicts a schematic diagram of a unidirectional transmission device 100J according to one embodiment of the present disclosure. Compared with the unidirectional transmission device 100I shown in FIG. 10, the disposition of the first conductor 140J and the second conductor 150J of the unidirectional transmission device 100J shown in FIG. 11 is different.

As shown in FIG. 11, the first conductor 140J and the second conductor 150J are covered on the outside of the at least one substrate 110J in order to connect to the at least one light source 120J and the at least one light-sensing element 130J respectively. In one embodiment, the first conductor 140J and the second conductor 150J can be formed on the outside of the at least one substrate 110J by coating. It is noted that, the element in FIG. 11, whose symbol is similar to the symbol of the element in FIG. 10, has similar structure feature in connection with the element in FIG. 10. Therefore, a detail description regarding the structure feature of the element in FIG. 11 is omitted herein for the sake of brevity. Furthermore, the present disclosure is not limited to the structure as shown in FIG. 11, and it is merely an example for illustrating one of the implements of the present disclosure.

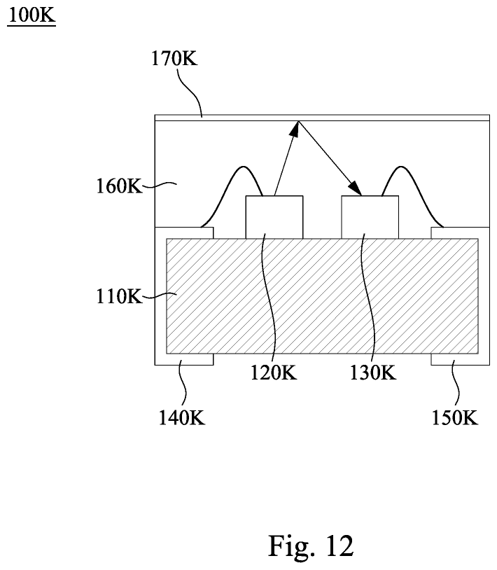

FIG. 12 depicts a schematic diagram of a unidirectional transmission device 100K according to one embodiment of the present disclosure. Compared with the unidirectional transmission device 100J shown in FIG. 11, the disposition of the reflecting layer 170K of the unidirectional transmission device 100K shown in FIG. 12 is different.

As shown in FIG. 12, the reflecting layer 170K of the unidirectional transmission device 100K can be a flat surface reflecting layer. It is noted that, the element in FIG. 12, whose symbol is similar to the symbol of the element in FIG. 11, has similar structure feature in connection with the element in FIG. 11. Therefore, a detail description regarding the structure feature of the element in FIG. 12 is omitted herein for the sake of brevity. Furthermore, the present disclosure is not limited to the structure as shown in FIG. 12, and it is merely an example for illustrating one of the implements of the present disclosure. It will be apparent to those skilled in the art that various modifications and variations can be made to the shape of the reflecting layer 170K of the present disclosure without departing from the scope or spirit of the present disclosure.

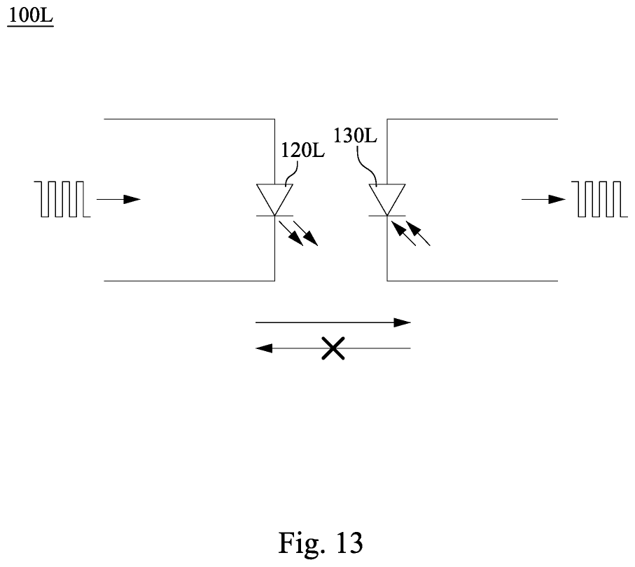

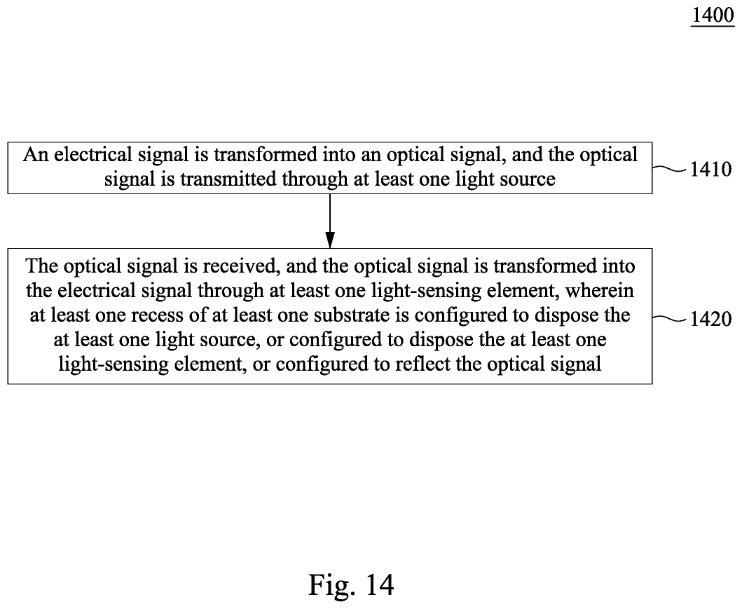

FIG. 13 depicts a schematic diagram of a unidirectional transmission device 100L according to one embodiment of the present disclosure. As shown in the figure, the optical signal radiated by the at least one light source 120L can be transmitted to the at least one light-sensing element 130L in a unidirectional manner. The detailed operations of the signal transmission are described in the description of the following FIG. 14.

FIG. 14 depicts a flowchart of a method 1400 for transmitting signals in a unidirectional manner according to one embodiment of the present disclosure. As shown in the figure, the method 1400 for transmitting signals in a unidirectional manner includes the following steps. In step 1410, an electrical signal is transformed into an optical signal, and the optical signal is transmitted through at least one light source. In step 1420, the optical signal is received, and the optical signal is transformed into the electrical signal through at least one light-sensing element, wherein at least one recess of at least one substrate is configured to dispose the at least one light source, or configured to dispose the at least one light-sensing element, or configured to reflect the optical signal.

For facilitating the understanding of the method 1400 for transmitting signals in a unidirectional manner, please refer to FIG. 1. In step 1410, the electrical signal is transformed into the optical signal through the at least one light source 120, and the optical signal is transmitted through the at least one light source 120. In step 1420, the optical signal is received through the at least one light-sensing element 130, and the optical signal is transformed into the electrical signal through the at least one light-sensing element 130. The at least one recess 111 of the at least one substrate 110 is configured to reflect the optical signal.

In one embodiment, the method 1400 for transmitting signals in a unidirectional manner further includes the following steps: transmitting the electrical signal to the at least one light source through the first conductor, receiving the electrical signal from the at least one light-sensing element through the second conductor, and transmitting the electrical signal through the second conductor. For example, reference is now made to FIG. 1. The first conductor 140 in the present disclosure can be used to transmit the electrical signal to the at least one light source 120. The at least one light source 120 performs a transformation between an optical signal and an electrical signal, and transmits the optical signal to the at least one light-sensing element 130. The at least one light-sensing element 130 performs a transformation between an optical signal and an electrical signal to generate the electrical signal. The second conductor 150 can be used to receive the electrical signal from the at least one light-sensing element 130, and transmit the electrical signal.

In one embodiment, the first conductor 140 is isolated from the second conductor 150. For example, referring to FIG. 1, the first conductor 140 is not physically connected to the second conductor 150. In addition, the first conductor 140 is not directly or indirectly connected to the second conductor 150 in an electrical manner. In another embodiment, the optical signal is reflected twice to be received by the at least one light-sensing element 130. For example, referring to FIG. 1, the at least one light source 120 outputs the optical signal, and the optical signal is reflected by the first reflecting surface 113 for the first time, and reflected by the second reflecting surface 115 for the second time to be received by the at least one light-sensing element 130.

In one embodiment, the method 1400 for transmitting signals in a unidirectional manner further includes the following steps: transmitting the optical signal to the reflecting layer through the at least one light source, and reflecting the optical signal to the at least one light-sensing element through the reflecting layer. For example, referring to FIG. 4, the at least one light source 120C in the present disclosure can be used to transmit the optical signal to the reflecting layer 170C, and the reflecting layer 170C can be used to reflect the optical signal to the at least one light-sensing element 130C.

In another embodiment, the method 1400 for transmitting signals in a unidirectional manner further includes the following steps: reflecting the optical signal to the at least one light-sensing element through a curved surface of the reflecting layer. For example, referring to FIG. 6, a curved surface 171E of the reflecting layer 170E in the present disclosure can be used to reflect the optical signal to the at least one light-sensing element 130E.

It can be understood from the embodiments of the present disclosure that application of the present disclosure has the following advantages. If electrical devices adopt the unidirectional transmission device and the method for transmitting signals in a unidirectional manner of the present disclosure to perform transaction certification, the security of the transaction certification is increased due to the unidirectional transmission characteristic of the unidirectional transmission device. Since data related to transaction can be transmitted in a unidirectional manner, the data related to transaction cannot be obtained reversely so as to ensure the security of the transaction certification.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A unidirectional transmission device, comprising:
at least one substrate, comprising at least one recess;
at least one light source, configured to transform an electrical signal into an optical signal, and transmit the optical signal; and
at least one light-sensing element, configured to receive the optical signal, and transform the optical signal into the electrical signal, wherein the at least one recess is configured to dispose the at least one light source, or configured to dispose the at least one light-sensing element, or configured to reflect the optical signal.

2. The unidirectional transmission device of claim 1, further comprising:
a first conductor, wherein the at least one light source is connected to the first conductor in a flip bonding manner; and
a second conductor, wherein the at least one light-sensing element is connected to the second conductor in a flip bonding manner.

3. The unidirectional transmission device of claim 2, wherein the first conductor is isolated from the second conductor.

4. The unidirectional transmission device of claim 2, wherein the first conductor and the second conductor respectively penetrate the at least one substrate in order to connected to the at least one light source and the at least one light-sensing element.

5. The unidirectional transmission device of claim 2, wherein the first conductor and the second conductor respectively cover the at least one substrate in order to connected to the at least one light source and the at least one light-sensing element.

6. The unidirectional transmission device of claim 2, wherein the first conductor and the second conductor are located on a surface of the at least one substrate, and the first conductor and the second conductor are respectively connected to the at least one light source and the at least one light-sensing element.

7. The unidirectional transmission device of claim 1, wherein the optical signal is reflected twice to be received by the at least one light-sensing element.

8. The unidirectional transmission device of claim 1, wherein the at least one recess comprises:
a first reflecting surface, configured to reflect the optical signal from the at least one light source; and
a second reflecting surface, configured to reflect the optical signal from the first reflecting surface, and transmit the optical signal to the at least one light-sensing element.

9. The unidirectional transmission device of claim 1, wherein the at least one recess further comprises:
a medium, configured to transmit the optical signal, wherein the medium comprises one of air, silicon, silica, polymer, and an element which is penetrable by light with wavelength ranges from 750 nm to 1650 nm.

10. The unidirectional transmission device of claim 1, further comprising:
a reflecting layer, disposed above the at least one substrate, wherein the at least one light source transmits the optical signal to the reflecting layer, and the reflecting layer reflects the optical signal to the at least one light-sensing element.

11. The unidirectional transmission device of claim 10, further comprising:
a first conductor, wherein the at least one light source is disposed in the at least one recess, and connected to the first conductor; and
a second conductor, wherein the at least one light-sensing element is disposed in the at least one recess, and connected to the second conductor.

12. The unidirectional transmission device of claim 11, wherein the first conductor is isolated from the second conductor.

13. The unidirectional transmission device of claim 11, wherein the first conductor and the second conductor respectively penetrate the at least one substrate in order to connected to the at least one light source and the at least one light-sensing element.

14. The unidirectional transmission device of claim 11, wherein the first conductor and the second conductor respectively cover the at least one substrate in order to connected to the at least one light source and the at least one light-sensing element.

15. The unidirectional transmission device of claim 10, wherein the reflecting layer comprises a curved surface, wherein the at least one light source transmits the optical signal to the curved surface of the reflecting layer, and the curved surface of the reflecting layer reflects the optical signal to the at least one light-sensing element.

16. The unidirectional transmission device of claim 1, wherein the at least one substrate comprises:
a first substrate, comprising a first recess, wherein the at least one light-sensing element is disposed in the first recess; and
a second substrate, comprising a second recess, wherein the at least one light source is disposed in the second recess.

17. The unidirectional transmission device of claim 16, wherein the first recess and the second recess are disposed face to face.

18. The unidirectional transmission device of claim 1, wherein the at least one substrate comprises:
a first substrate, comprising the at least one recess, wherein the at least one light-sensing element is disposed in the at least one recess; and
a second substrate, wherein the at least one light source is disposed on the second substrate.

19. The unidirectional transmission device of claim 18, further comprising:
a first conductor, configured to penetrate the first substrate and connect to the at least one light source through a third conductor; and
a second conductor, configured to penetrate the first substrate and connect to the at least one light-sensing element.

20. The unidirectional transmission device of claim 19, wherein the first conductor is isolated from the second conductor.

21. A unidirectional transmission device, comprising:
at least one substrate;
a reflecting layer, disposed above the at least one substrate;
at least one light source, disposed on the substrate, configured to transform an electrical signal into an optical signal, and transmit the optical signal to the reflecting layer; and
at least one light-sensing element, disposed on the substrate, configured to receive the optical signal from the reflecting layer, and transform the optical signal into the electrical signal.

22. The unidirectional transmission device of claim 21, further comprising:
a first conductor, connected to the at least one light source; and
a second conductor, connected to the at least one light-sensing element.

23. The unidirectional transmission device of claim 22, wherein the first conductor is isolated from the second conductor.

24. The unidirectional transmission device of claim 22, wherein the first conductor and the second conductor respectively penetrate the at least one substrate in order to connected to the at least one light source and the at least one light-sensing element.

25. The unidirectional transmission device of claim 22, wherein the first conductor and the second conductor respectively cover the at least one substrate in order to connected to the at least one light source and the at least one light-sensing element.

26. The unidirectional transmission device of claim 21, wherein the reflecting layer comprises a curved surface, wherein the at least one light source transmits the optical signal to the curved surface of the reflecting layer, and the curved surface of the reflecting layer reflects the optical signal to the at least one light-sensing element.

27. A method for transmitting signals in a unidirectional manner, comprising:
transforming an electrical signal into an optical signal, and transmitting the optical signal through at least one light source; and
receiving the optical signal, and transforming the optical signal into the electrical signal through at least one light-sensing element, wherein at least one recess of at least one substrate is configured to dispose the at least one light source, or configured to dispose the at least one light-sensing element, or configured to reflect the optical signal.

28. The method for transmitting signals in a unidirectional manner of claim 27, further comprising:
transmitting the electrical signal to the at least one light source through a first conductor; and
receiving the electrical signal from the at least one light-sensing element, and transmitting the electrical signal through a second conductor.

29. The method for transmitting signals in a unidirectional manner of claim 28, wherein the first conductor isolated from the second conductor.

30. The method for transmitting signals in a unidirectional manner of claim 27, wherein the optical signal is reflected twice to be received by the at least one light-sensing element.

31. The method for transmitting signals in a unidirectional manner of claim 27, further comprising:
transmitting the optical signal to a reflecting layer through the at least one light source;
reflecting the optical signal to the at least one light-sensing element through the reflecting layer.

32. The method for transmitting signals in a unidirectional manner of claim 31, wherein reflecting the optical signal to the at least one light-sensing element through the reflecting layer comprises:
reflecting the optical signal to the at least one light-sensing element through a curved surface of the reflecting layer.
